(19) United States
(12) Patent Application Publication
(10) Pub. No.: US 2017/0372356 A1
(43) Pub. Date: Dec. 28, 2017

(54) EVALUATION OF ADVERTISING EFFECTIVENESS

(71) Applicant: Analytics Media Group, LLC, New York, NY (US)

(72) Inventors: Christopher W. Frommann, New York, NY (US); Scott M. Safranek, Brooklyn, NY (US); Gaurav S. Shirole, Brooklyn, NY (US); Maxim D. Wilson, New York, NY (US)

(73) Assignee: Analytics Media Group, LLC, New York, NY (US)

(21) Appl. No.: 15/635,411

(22) Filed: Jun. 28, 2017

Related U.S. Application Data
(60) Provisional application No. 62/355,756, filed on Jun. 28, 2016.

(51) Int. Cl. G06Q 30/02

(52) U.S. Cl. CPC G06Q 30/0246

(57) ABSTRACT

A system for evaluating advertising effectiveness operates to generate a customer conversion outcome that shows how effectively a desired outcome has been achieved by an advertising campaign. The effectiveness of advertising campaign can be evaluated in light of control customer conversion information that reflects different conversion propensities of customers.

### CROSS-REFERENCE TO RELATED APPLICATION

This application claims priority to U.S. Provisional Application No. 62/355,756, filed on Jun. 28, 2016, and titled EVALUATION OF ADVERTISING EFFECTIVENESS, the disclosure of which is hereby incorporated by reference in its entirety.

### BACKGROUND

Advertising is typically performed in various types of media, such as print advertising, television, radio, telephone, and electronic media distributed via electronic communications. A primary goal of the advertising is to not only make effective advertising content but also the most effective return on investment by allocating advertisements to influence as many viewers in a target population as possible in a cost effective manner.

Advertising effectiveness pertains to how well advertising accomplishes an intended purpose. Various statistics or metrics are used to measure advertising effectiveness. For example, one metric for advertising effectiveness is reach, which pertains to the number of people who actually saw the advertisement. Other metrics include increase in sales and profits after advertising. Processes for utilizing such statistics or metrics can be improved to better evaluate advertising effectiveness.

### SUMMARY

In general terms, this disclosure is directed to a system for evaluating advertising effectiveness. In one possible configuration and by non-limiting example, the system is configured to generate a customer conversion outcome that shows how effectively a desired outcome has been achieved by an advertising campaign. The effectiveness of advertising campaign can be evaluated in light of control customer conversion information that reflects different conversion propensities of customers. Various aspects are described in this disclosure, which include, but are not limited to, the following aspects.

One aspect is a computer storage medium including computer executable instructions that, when executed by at least one processing device, cause the at least one processing device to: receive viewership data and advertisement run data; generate advertisement exposure data based on the viewership data and the advertisement run data, the advertisement exposure data including information about advertisements presented to an advertisement audience; receive customer data, the customer data including conversion information that represents whether a desired outcome has been achieved by the advertisement campaign; and generate a customer conversion outcome based on the advertisement exposure data and the customer data.

Another aspect is a system of evaluating an advertising campaign. The system includes at least one processing devices; a computer readable storage device storing software instructions that, when executed by the one or more computing devices, cause the one or more processing devices to: receive viewership data and advertisement run data; generate advertisement exposure data based on the viewership data and the advertisement run data, the advertisement exposure data including information about advertisements presented to an advertisement audience; receive customer data, the customer data including conversion information that represents whether a desired outcome has been achieved by the advertisement campaign; and generate a customer conversion outcome based on the advertisement exposure data and the customer data.

Yet another aspect is a method of evaluating an advertising campaign, the method comprising: receiving viewership data and advertisement run data; generating, using at least one computing device, advertisement exposure data based on the viewership data and the advertisement run data, the advertisement exposure data including information about advertisements presented to an advertisement audience; receiving customer data, the customer data including conversion information that represents whether a desired outcome has been achieved by the advertisement campaign; and generating, using the at least one computing device, a customer conversion outcome based on the advertisement exposure data and the customer data.

### BRIEF DESCRIPTION OF THE DRAWINGS

FIG. 1 is a schematic diagram of an example system for evaluating advertisement effectiveness.

FIG. 2 illustrates an exemplary architecture of a computing device that can be used to implement aspects of the present disclosure.

FIG. 3 is a flowchart of an example method of operating an advertisement evaluation system.

FIG. 4 is an example functional block diagram of the advertisement evaluation system.

FIG. 5 is a block diagram of an example advertisement exposure analysis device.

FIG. 6 illustrates an example structure of viewership data.

FIG. 7 illustrates a portion of example household-based viewership data provided by a viewership data provider.

FIG. 8 illustrates an example structure of individual-based viewership data.

FIG. 9 illustrates an example structure of advertisement run data.

FIG. 10 illustrates a portion of example advertisement run data provided by an advertisement run data provider.

FIG. 11 illustrates an example structure of advertisement exposure data.

FIG. 12 is a block diagram of an example customer conversion analysis device.

FIG. 13 illustrates an example structure of customer data.

FIG. 14 illustrates a portion of example customer data retrieved from a CRM database.

FIG. 15 illustrates an example structure of propensity-augmented conversion data.

FIG. 16 illustrates an example method of determining propensity levels.

FIG. 17 illustrates an example customer conversion outcome.

FIG. 18 illustrates another example customer conversion outcome.

FIG. 19 is a block diagram of another example advertisement evaluation system.

FIG. 20 is a flowchart illustrating an example method of evaluating the effectiveness of advertising campaign.

FIG. 21 shows two example customer conversion outcomes to illustrate example evaluation methods.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

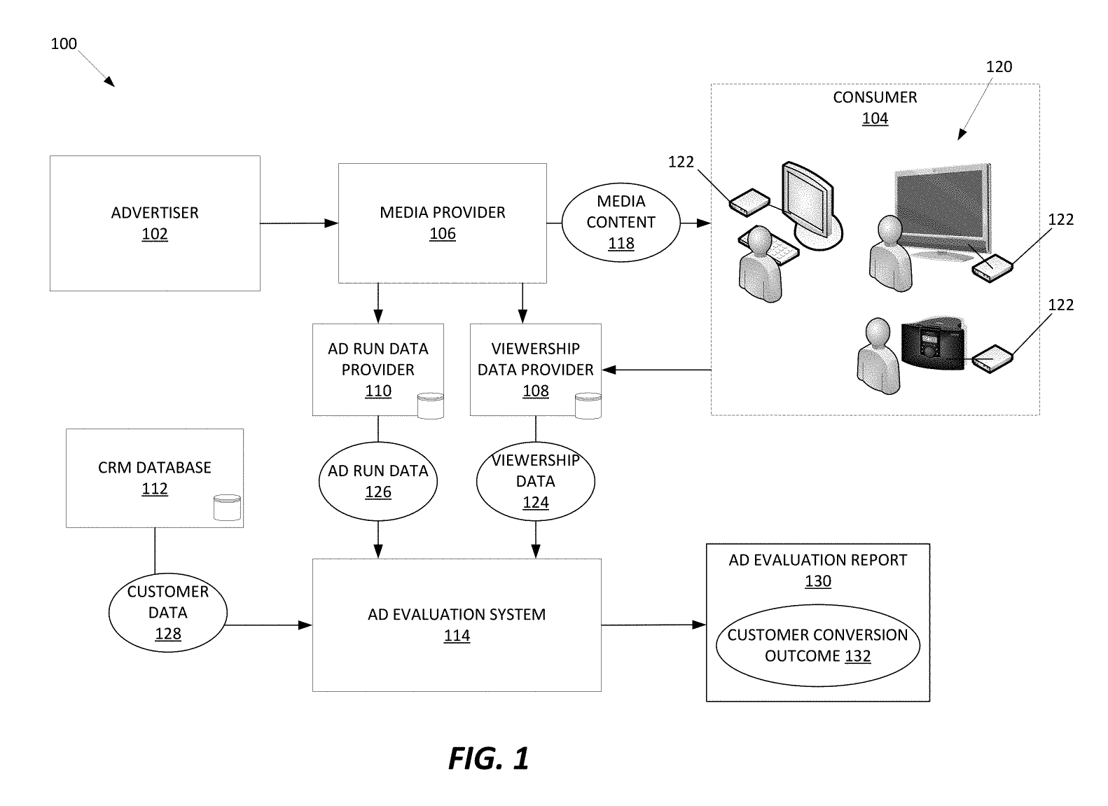

FIG. 1 is a schematic diagram of an example system 100 for evaluating advertisement effectiveness. In some embodiments, the system 100 includes an advertiser 102, a consumer 104, a media provider 106, a viewership data provider 108, an advertisement run data provider 110, a customer relationship management database 112, and an advertisement evaluation system 114. Also shown are media content 118, one or more media delivery devices 120, one or more viewership data collection devices 122, viewership data 124, advertisement run data 126, customer data 128, and an advertisement evaluation report 130 including customer conversion outcome 132.

In various embodiments, the system 100 includes the advertisement evaluation system 114 configured to evaluate advertising effectiveness and generate an evaluation report 130 to the advertiser 102. As described herein, the evaluation report 130 generated by the advertisement evaluation system 114 includes customer conversion outcome 132 and helps the advertiser 102 determine advertising strategies that improve advertising effects in a cost-efficient manner (i.e., increase in the return on investment (ROI) of advertising).

In the present disclosure, embodiments of the system 100 are primarily described and illustrated in the context of running race promotion advertising. However, it is apparent that the system 100 is applicable to other types of marketing campaign, such as an advertising campaign for a product (e.g., retail), service (e.g., hotel and travel), entertainment media (e.g., HBO, NBC, AMC, and New Regency), and a political campaign.

The advertiser 102 is a person, group, organization, or company that promotes a product, service, business, candidate, cause, and/or other objectives in various marketing campaigns. For example, the advertiser 102 is organized to manage an advertising campaign for running events (e.g., marathon). In the advertising campaign, the advertiser 102 can perform a coordinated series of steps that include promotion of a product and/or service through different media using a variety of different types of advertisements. Examples of the advertiser 102 include advertising professionals, agencies, and media researchers.

The consumer 104 is a group of people who can change their behavior, or perform an event, as intended by the advertising campaign. In some examples, the consumer 104 can purchase a product or service, or attend an event, which is advertised on the media. In a running event campaign, the consumer 104 can be potential runners. The consumer 104 is the target of the advertising, which is designed to persuade them to join the running event. The consumer 104 receives media content 118 via different media delivery devices 120. Examples of the media delivery devices 120 include televisions, radios, computers, mobile devices, and other electronic devices.

The media provider 106 is one or more companies or organizations that deliver media content 118 to the consumer 104 via different media delivery devices 120. In some embodiments, the media provider 106 includes television broadcasting companies, cable television companies, radio broadcasting companies, telecommunications companies, Internet service providers, Internet content providers, and other program delivery sources. The media content 118 is intended to be delivered on the media delivery devices 120 and serves as attraction for viewership. In some embodiments, the media content 118 includes television programs, cable programs, radio programs, and streaming video or audio. As described herein, the media content 118 also includes advertising content. In some embodiments, the placement of advertising content can be adjusted based on the advertisement evaluation report 130 generated by the advertisement evaluation system 114.

In some embodiments, the advertiser 102 can purchase one or more placement blocks of media content 118 from the media provider 106. The placement block is defined as a time slot for advertisement within or between different media programs delivered by a media provider 106. For example, the advertiser 102 can buy a certain number of placement blocks for advertisement between and/or in the middle of regularly scheduled television programs from a television broadcasting company. The advertiser 102 tries to design its campaign plans to choose placement blocks (e.g., time slots and media) for advertisement that can increase effectiveness of advertising (e.g., ROI).

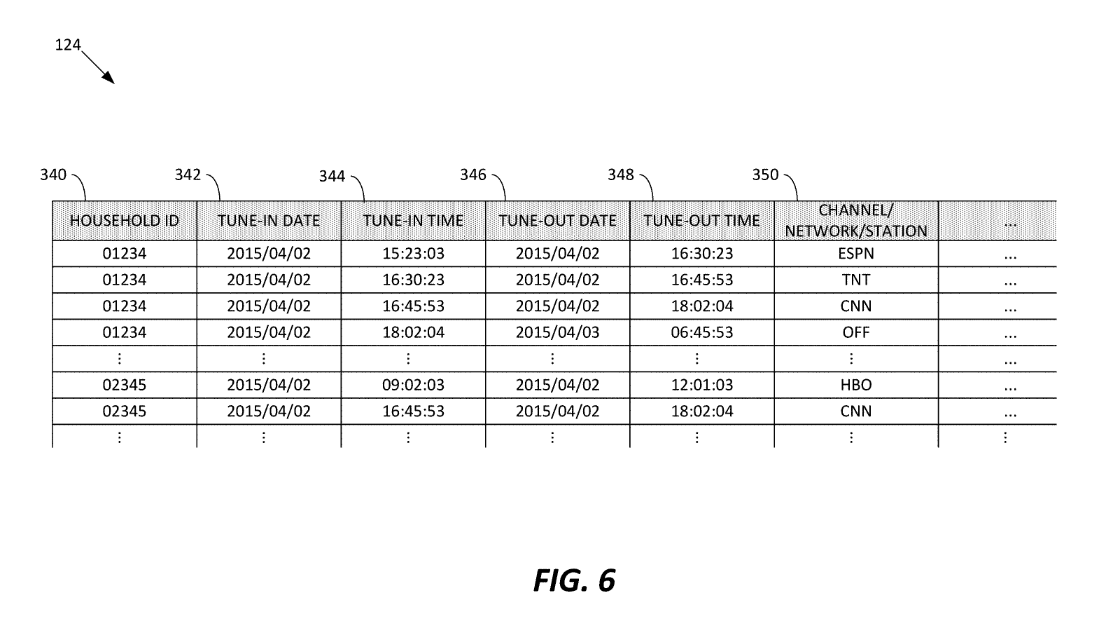

The viewership data provider 108 is one or more companies or organizations that generate and provide viewership data 124. As described herein, the viewership data 124 can include media measurement and other analytical services. An example of the viewership data 124 is illustrated and described in more detail with reference to FIG. 6. In some embodiments, the viewership data provider 108 monitors and evaluates media content 118 provided by the media provider 106, and provides information about consumers as the viewership data 124. For example, the viewership data provider 108 tracks viewing behavior from a number of televisions across a plurality of markets. The media measurement provided by the viewership data provider 108 is used by the advertisement evaluation system 114 to help the advertiser 102 target customers with high prospects, thereby allowing the advertiser 102 make a decision that improves the return on investment in advertising. Examples of the viewership data provider 108 include Rentrak Corporation (Portland, Oreg.), Kantar Group (Fairfield, Conn.), Fyi (Newark, N.J.), FourthWall Media (Dulles, Va.), Comcast (Philadelphia, Pa.), Time Warner (New York, N.Y.), Charter (St. Louis, Mo.), and other cable providers. In other embodiments, the viewership data provider 108 includes at least part of the media provider 106.

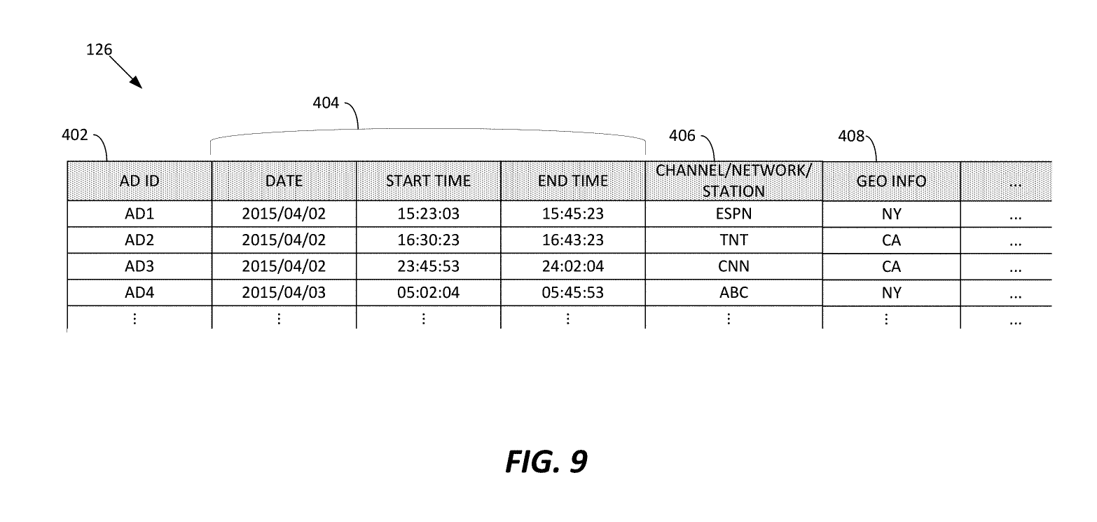

The advertisement run data provider 110 is one or more companies or organizations that generate and provide advertisement run data 126. As described herein, the advertisement run data 126 include a comprehensive time-stamped record of each of the advertisements run on the media delivery device 120. An example of the advertisement run data 126 is illustrated and described in more detail with reference to FIG. 9. In some embodiments, the advertisement run data provider 110 monitors and evaluates the media content 118 provided by the media provider 106, and provides information about the advertisements delivered to the consumer 104. As described herein, the advertisement run data 126 are delivered and/or transmitted to the advertisement evaluation system 114 and used with the viewership data 124 and the customer data 128 to generate an advertisement evaluation report 130.

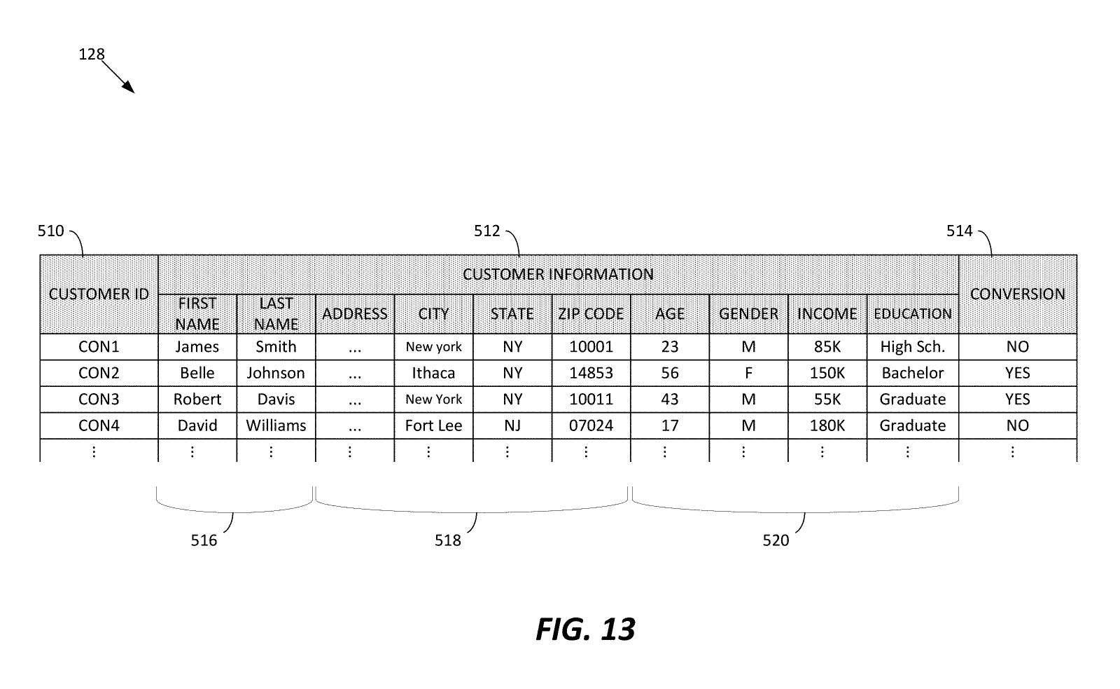

The customer relationship management (CRM) database 112 includes information about a company's interaction with existing and/or potential customers. The CRM database 112 includes customer data 128 that are provided to the advertisement evaluation system 114. An example of the customer data 128 is illustrated and described in more detail with reference to FIG. 13. In some embodiments, the CRM database 112 is used to provide a customer-oriented feature with service response based on customer input, one-to-one solutions to customer's requirements, direct online communications with customer and customer service centers that help customers solve their issues. The information stored in the CRM database 112 can be used to implement sales promotion, automate tracking of a client's account history for repeated sales or future sales, and coordinate sales, marketing, call centers, and retail outlets in order to realize the salesforce automation. The CRM database 112 can also aggregate transaction information, merge the information with CRM products or services, and provide a key performance indicator (KPI) that represents a success of the products or services.

In some embodiments, the customer relationship management database 112 is managed by a company that provides goods and/or services to the consumer 104. The advertiser 102 organizes an advertising campaign for promoting such goods and/or services for the company. The advertiser 102 can be part of the company. In other embodiments, the customer relationship management database 112 is operated by a third party other than the company.

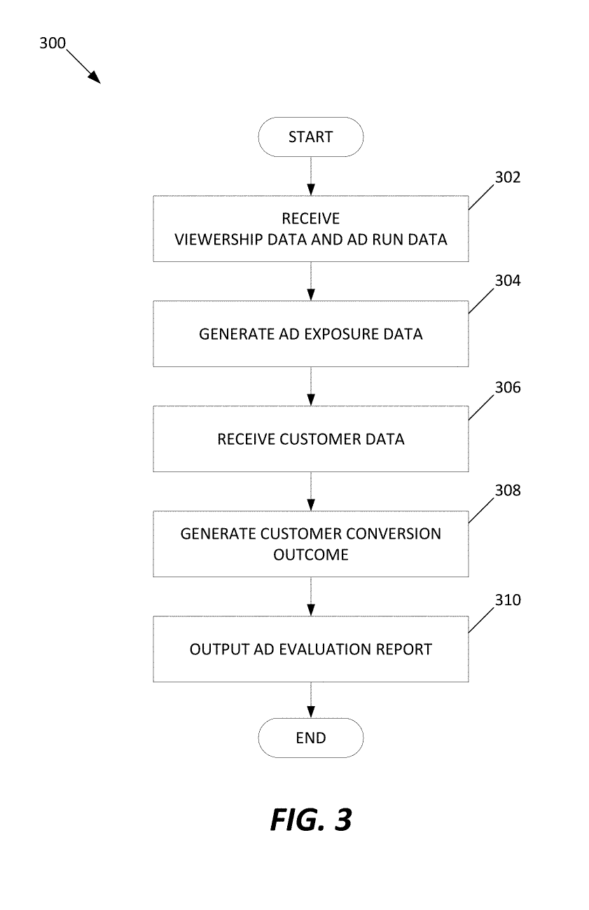

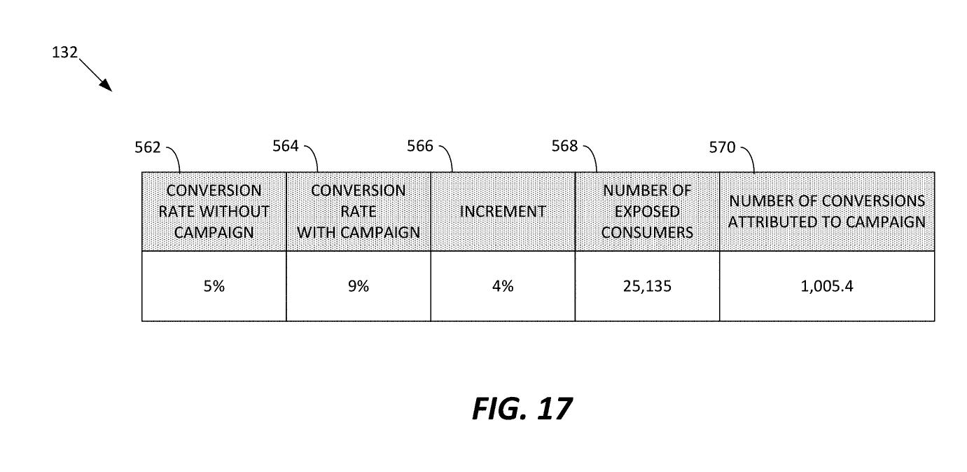

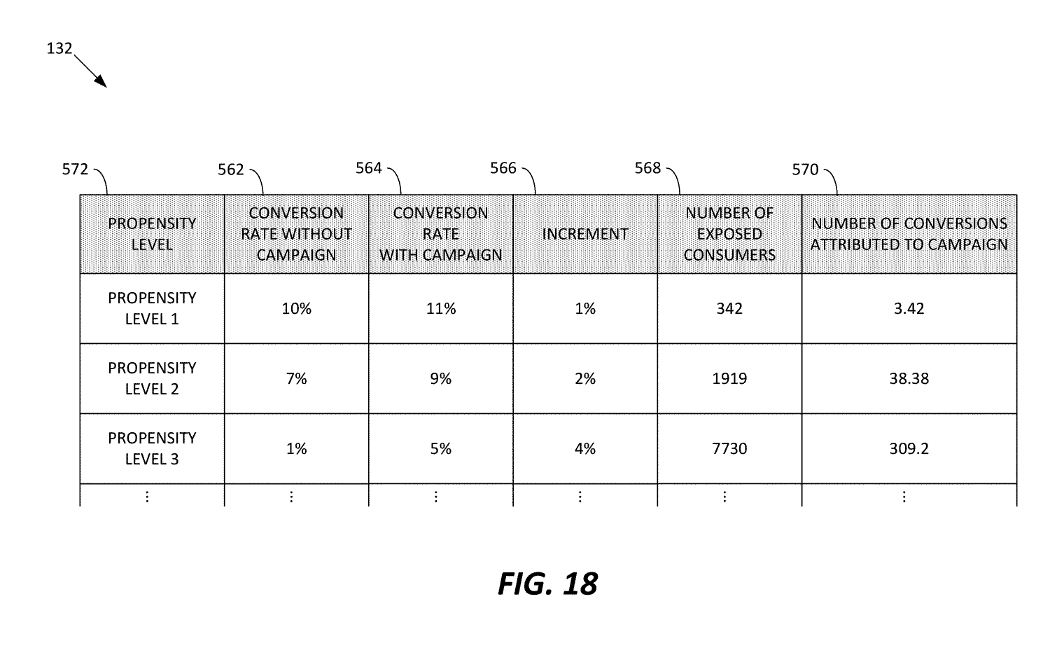

The advertisement evaluation system 114 operates to evaluate the effectiveness of advertising. In some embodiments, the advertisement evaluation system 114 determines how effective the advertising campaign was once the advertisements have been delivered to the consumer 104. The advertisement evaluation system 114 provides the advertiser 102 with an advertisement evaluation report 130 so that the advertiser 102 develops a new advertising campaign, or adjust a current advertising campaign, to increase the return on investment. The advertisement evaluation system 114 allows the advertiser 102 to estimate the marketing effects of advertising by providing customer conversion outcome 132. An example of the customer conversion outcome 132 is illustrated and described in more detail with reference to FIGS. 17 and 18. The advertisement evaluation report 130 including the customer conversion outcome 132 helps the advertiser 102 reach its most intended consumer 104 and develops a more effective and efficient advertising schedule. An example of the advertisement evaluation system 114 is described and illustrated with reference to FIG. 3.

The media content 118 is intended to be delivered on the media delivery devices 120. The media content 118 can be of various types, such as television programs, cable programs, radio programs, and streaming video or audio. The media content 118 also includes advertising content.

The media delivery devices 120 are configured to provide the media content 118 to the consumer 104. For examples, the media delivery devices 120 can be televisions, radios, computers, mobile devices, and other electronic devices.

The viewership data collection device 122 is hardware and/or software (e.g., computer readable instructions) introduced into a household in addition to or to supplement the media delivery device 120 and externally operatively associated with the media delivery device 120. The primary purpose of a viewership data collection device 122 is to collect the viewership data 124 including viewership data, purchase data, and/or other media-related data. For example, in embodiments of television viewership, a set top box associated with a television in a household operates to obtain set top box data. The set top box data contain various media-related data, at least of which are used in the viewership data 124. An example content of the viewership data 124 is illustrated and described in more detail with reference to FIG. 6. In addition or alternatively, the viewership data collection device 122 is configured to collect the advertisement run data 126.

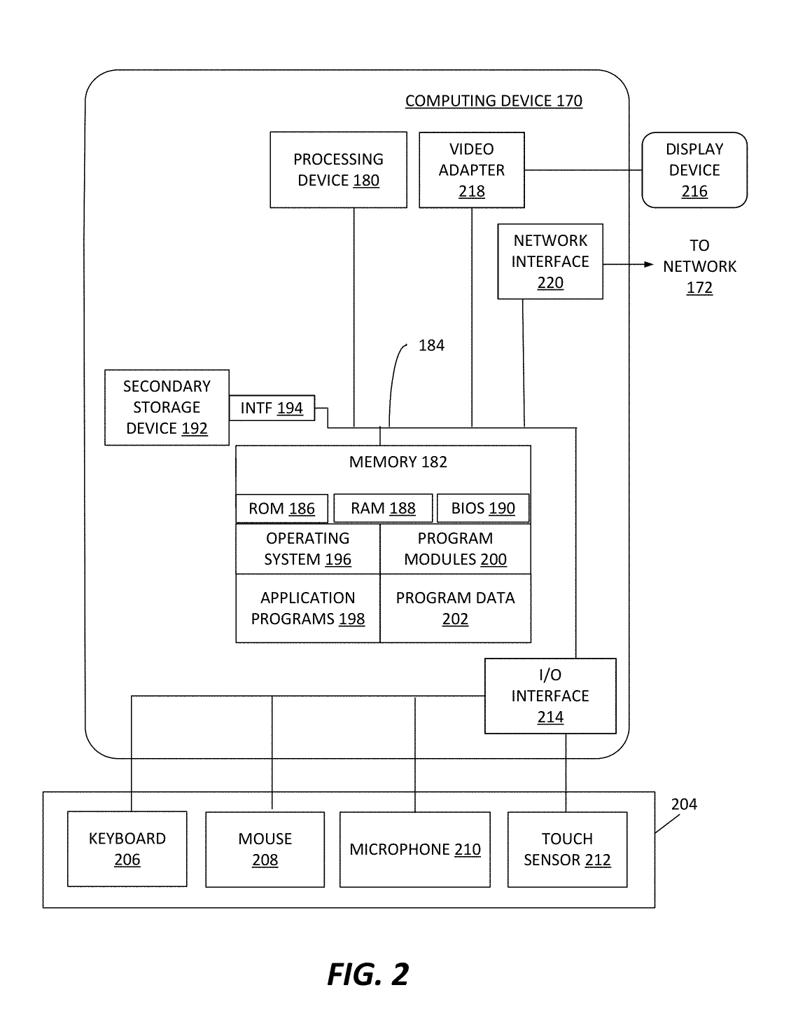

FIG. 2 illustrates an exemplary architecture of a computing device that can be used to implement aspects of the present disclosure, including the advertisement evaluation system 114 and any other computing devices associated with the system 100. The computing device illustrated in FIG. 2 can be used to execute the operating system, application programs, and software modules (including the software engines) described herein. By way of example, the computing device will be described below for the advertisement evaluation system 114 or a computing device 170 associated with the system 114. To avoid undue repetition, this description of the computing device will not be separately repeated herein for each of the other computing devices that are used in the system 100, but such devices can also be configured as illustrated and described with reference to FIG. 2.

The computing device 170 includes, in some embodiments, at least one processing device 180, such as a central processing unit (CPU). A variety of processing devices are available from a variety of manufacturers, for example, Intel or Advanced Micro Devices. In this example, the computing device 170 also includes a system memory 182, and a system bus 184 that couples various system components including the system memory 182 to the processing device 180. The system bus 184 is one of any number of types of bus structures including a memory bus, or memory controller; a peripheral bus; and a local bus using any of a variety of bus architectures.

Examples of computing devices suitable for the computing device 170 include a desktop computer, a laptop computer, a tablet computer, a mobile computing device (such as a smart phone, an iPod® or iPad® mobile digital device, or other mobile devices), or other devices configured to process digital instructions.

The system memory 182 includes read only memory 186 and random access memory 188. A basic input/output system 190 containing the basic routines that act to transfer information within computing device 170, such as during start up, is typically stored in the read only memory 186.

The computing device 170 also includes a secondary storage device 192 in some embodiments, such as a hard disk drive, for storing digital data. The secondary storage device 192 is connected to the system bus 184 by a secondary storage interface 194. The secondary storage devices 192 and their associated computer readable media provide nonvolatile storage of computer readable instructions (including application programs and program modules), data structures, and other data for the computing device 170.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 192 or memory 182, including an operating system 196, one or more application programs 198, other program modules 200 (such as the software engines described herein), and program data 202. The computing device 170 can utilize any suitable operating system, such as Microsoft Windows™, Google Chrome™, Apple OS, and any other operating system suitable for a computing device.

In some embodiments, a user provides inputs to the computing device 170 through one or more input devices 204. Examples of input devices 204 include a keyboard 206, mouse 208, microphone 210, and touch sensor 212 (such as a touchpad or touch sensitive display). Other embodiments include other input devices 204. The input devices are often connected to the processing device 180 through an input/output interface 214 that is coupled to the system bus 184. These input devices 204 can be connected by any number of input/output interfaces, such as a parallel port, serial port, game port, or a universal serial bus. Wireless communication between input devices and the interface 214 is possible as well, and includes infrared, BLUETOOTH® wireless technology, 802.11a/b/g/n, cellular, or other radio frequency communication systems in some possible embodiments.

In this example embodiment, a display device 216, such as a monitor, liquid crystal display device, projector, or touch sensitive display device, is also connected to the system bus 184 via an interface, such as a video adapter 218. In addition to the display device 216, the computing device 170 can include various other peripheral devices (not shown), such as speakers or a printer.

When used in a local area networking environment or a wide area networking environment (such as the Internet), the computing device 170 is typically connected to a network 172 through a network interface 220, such as an Ethernet interface. Other possible embodiments use other communication devices. For example, some embodiments of the computing device 170 include a modem for communicating across the network.

The computing device 170 typically includes at least some form of computer readable media. Computer readable media includes any available media that can be accessed by the computing device 170. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 170. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 2 is also an example of programmable electronics, which may include one or more such computing devices, and when multiple computing devices are included, such computing devices can be coupled together with a suitable data communication network so as to collectively perform the various functions, methods, or operations disclosed herein.

FIG. 3 is a flowchart of an example method 300 of operating the evaluation system 114. In some embodiments, the method 300 includes operations 302, 304, 306, 308, and 310.

At the operation 302, the evaluation system 114 operates to receive the viewership data 124 and the advertisement run data 126. As described herein, in some embodiments, the viewership data 124 is generated based on information collected from the viewership data collection devices 122 and provided by the viewership data provider 108. The advertisement run data 126 can be provided by the advertisement run data provider 110. In other embodiments, the viewership data 124 and the advertisement run data 126 can be provided by a same provider.

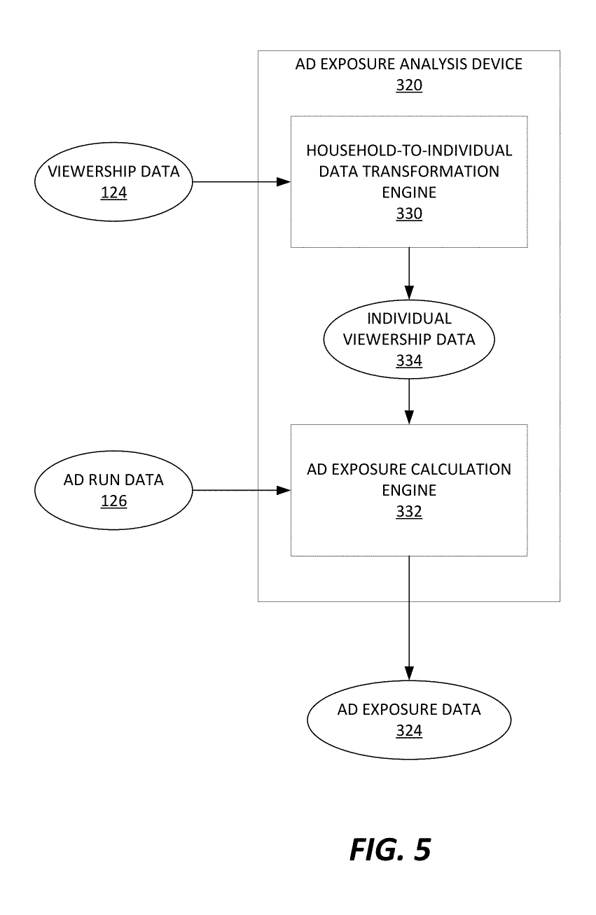

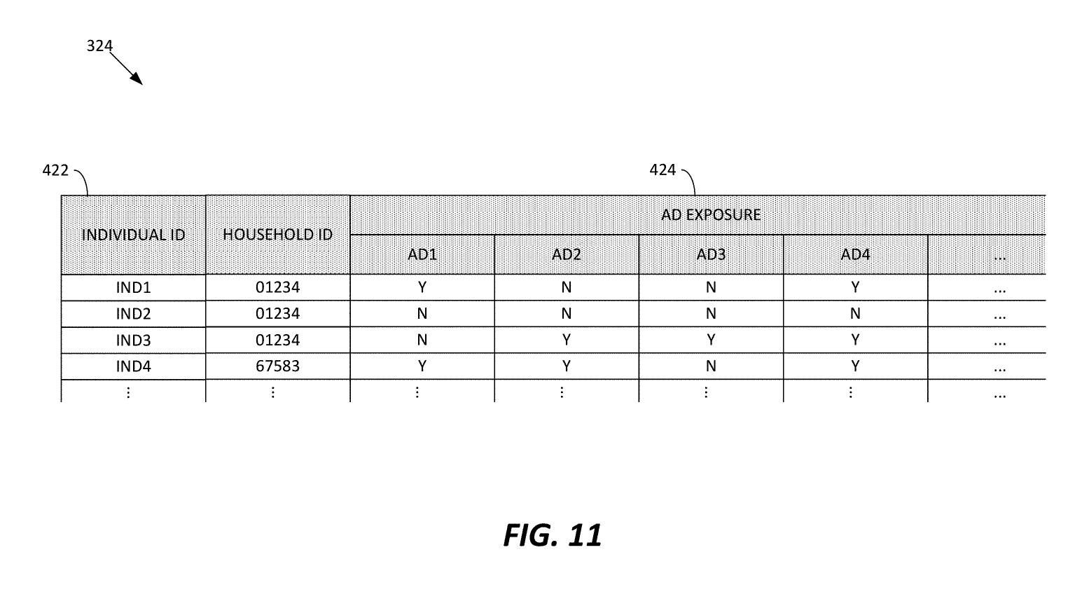

At the operation 304, the evaluation system 114 operates to generate advertisement exposure data 324 (FIG. 5) based on the viewership data 124 and the advertisement run data 126. As described below, the advertisement exposure data 324 contain information about advertisements presented to an advertisement audience, such as the consumer 104. An example of the advertisement exposure data 324 is described and illustrated in more detail with reference to FIG. 11.

At the operation 306, the evaluation system 114 operates to receive the customer data 128. In some embodiments, the customer data 128 is retrieved from the CRM database 112. As described below, the customer data 128 include conversion information that represents whether a desired outcome has been achieved by the advertising campaign. In some embodiments, the conversion information relates to whether the consumer 104 has performed an action intended by the advertising campaign. For example, where an advertising campaign is intended to promote a luxury sedan, the conversion information includes whether the consumer 104 has purchased the sedan. In other embodiments, such a desired outcome can be of various types of performances or inactivity as desired by an advertising campaign.

At the operation 308, the evaluation system 114 operates to generate customer conversion outcome 132. In some embodiments, the customer conversion outcome 132 contains a control conversion result (e.g., a pre-advertising conversion rate 562 in FIGS. 17 and 18) that can be used as reference data to determine an actual change (i.e., a net increase) after advertising. The customer conversion outcome 132 can also show conversion results by different propensity groups (e.g., by different propensity levels 572 in FIG. 18). Examples of the customer conversion outcome 132 is illustrated and described in more detail with reference to FIGS. 17 and 18.

At the operation 310, the evaluation system 114 operates to generate an advertisement evaluation report 130. The report 130 includes the customer conversion outcome 132. In some embodiments, the report 130 is transmitted and/or delivered to the advertiser 102. The advertiser 102 can use the report 130 to analyze the existing advertising campaign and devise strategies to improve the effectiveness of advertising.

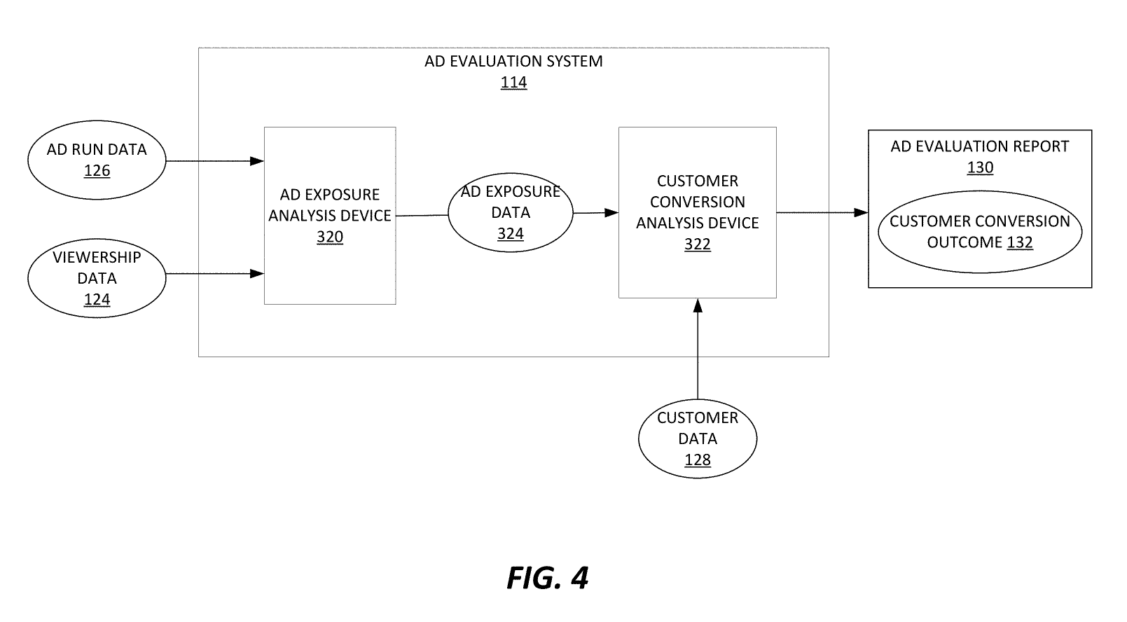

FIG. 4 is an example functional block diagram of the advertisement evaluation system 114. In some embodiments, the advertisement evaluation system 114 includes an advertisement (AD) exposure analysis device 320 and a customer conversion analysis device 322. Also shown is an advertisement (AD) exposure data 324.

The advertisement exposure analysis device 320 operates to determine households or individuals that were exposed to particular advertisements through the media delivery devices 120 at a particular time period, channel, station, and/or network, and geographic location. The advertisement exposure analysis device 320 can also determine the number and/or kind of advertisements each household or individual was exposed to.

In some embodiments, the advertisement exposure analysis device 320 operates to receive the viewership data 124 and the advertisement run data 126 and generate the advertisement exposure data 324 based on the viewership data 124 and the advertisement run data 126. In some embodiments, the AD exposure analysis device 320 performs the operations 302 and 304 as described in FIG. 3. An example of the AD exposure analysis device 320 is illustrated and described in more detail with reference to FIG. 5.

The customer conversion analysis device 322 operates to calculate a change in customer conversions that have been achieved by the advertising campaign. In some embodiments, the customer conversion analysis device 322 can determine customer conversions that have occurred, or would have occurred, without the advertising campaign. Such pre-advertising customer conversions can be used as a control data to evaluate a net change in customer conversions after the advertising campaign. The customer conversion analysis device 322 is also configured to determine different propensities of customers and categorize the result of customer conversions by different propensity levels.

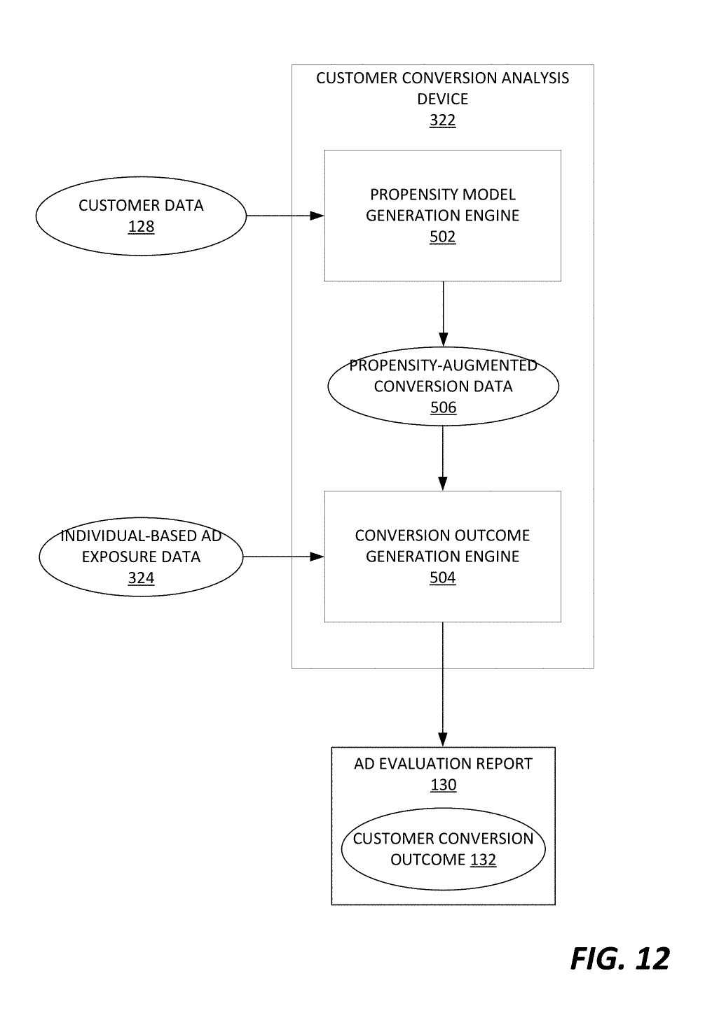

The customer conversion analysis device 322 operates to receive the AD exposure data 324 and the customer data 128 and generate the AD evaluation report 130 including the customer conversion outcome 132. In some embodiments, the customer conversion analysis device 322 performs the operations 306, 308, and 310 as described in FIG. 3. An example of the customer conversion analysis device 322 is described and illustrated in more detail with reference to FIG. 12.

Referring to FIGS. 5-11, an example operation of the AD exposure analysis device 320 is described.

FIG. 5 is a block diagram of an example AD exposure analysis device 320. In some embodiments, the AD exposure analysis device 320 includes a household-to-individual data transformation engine 330 and an advertisement exposure calculation engine 332. Also shown is individual-based viewership data 334.

The household-to-individual data transformation engine 330 is configured to transform the viewership data 124 to the individual-based viewership data 334 if the viewership data 124 is collected on a household basis. The household-to-individual data transformation engine 330 operates to convert the household-based viewership data 124 to an individual-based data where the customer conversion outcome 132 that is ultimately generated is on an individual-by-individual basis.

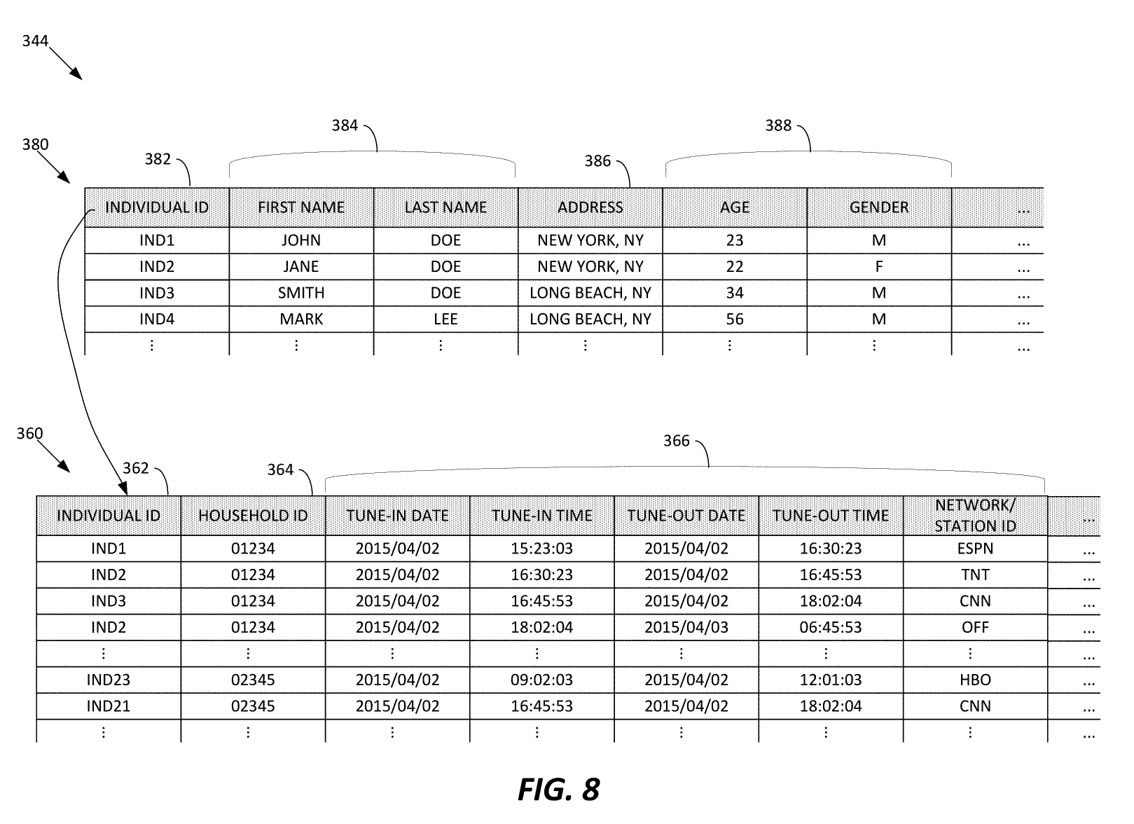

As shown in FIG. 6, the viewership data 124 contain records of tuning activities for a particular subset of population. In some embodiments, the viewership data 124 are generated on a household basis. For example, the viewership data 124 can include records of tuning activities that are categorized by different households. In this case, the viewership data 124 can be referred to as household-based viewership data 124. The household-to-individual data transformation engine 330 operates to transform the household-based viewership data 124 into the individual-based viewership data 334. As shown in FIG. 8, the individual-based viewership data 334 contain records of tuning activities that are categorized by different individuals.

The household-to-individual data transformation engine 330 employs various algorithms for transforming the household-based viewership data 124 to the individual-based viewership data 334. In some embodiments, the household-to-individual data transformation engine 330 uses a statistical model to probabilistically assign household-based viewership to individuals. By way of example, the household-to-individual data transformation engine 330 can employ Nielsen data that include both household and individual ratings to predict individual rating from household rating. In some examples, a linear regression analysis is used for such prediction. Other analyzing methods can also be used for prediction. In some embodiments, the household-to-individual data transformation engine 330 can employ an individual viewer information table 380 (FIG. 8).

The advertisement exposure calculation engine 332 operates to match the individual-based viewership data 334 and the advertisement run data 126 to generate the advertisement exposure data 324 that are identified on an individual-by-individual basis. An example of the advertisement exposure data 324 is illustrated and described with reference to FIG. 11.

In the illustrated example of FIG. 5, the advertisement exposure analysis device 320 first executes the household-to-individual data transformation engine 330 to generate the individual-based viewership data 334, and then runs the advertisement exposure calculation engine 332 to generate the individual-based advertisement exposure data 324. In other embodiments, however, the advertisement exposure analysis device 320 can execute the household-to-individual data transformation engine 330 and the advertisement exposure calculation engine 332 in different orders. For example, the advertisement exposure calculation engine 332 can first match the household-based viewership data 124 and the advertisement run data 126 to generate advertisement exposure data that are identified on a household-by-household basis. Then, the household-to-individual data transformation engine 330 can transform the household-based advertisement exposure data into the individual-based advertisement exposure data 324. The household-based advertisement exposure data are similar to the individual-based advertisement exposure data 324 except that it identifies whether each household, instead of each individual, was exposed to particular advertisements.

FIG. 6 illustrates an example structure of the viewership data 124.

In general, the viewership data 124 include audience measurement and program information. In some embodiments, audience measurement provides how many people and/or who are in an audience. In other embodiments, audience measurement provides how many households and/or which households are in an audience. Examples of audience measurement include television viewership, radio listenership, readership of newspaper or magazine, and web traffic on websites.

In some embodiments, audience measurement also includes geographic and demographic information of the viewers (either individuals or households) including location information with a household. In some embodiments, geographic data include market, country, state, county, street, house number, congressional district, state legislative district, municipal district, zip code, census data, census block, latitude and longitude, GPS coordinates, cable television zone, current location, work location, home location, and the like.

In some embodiments, the viewership data 124 are obtained by one or more viewership data collection devices 122. Examples of viewership data include rating data that measure viewership of particular programs, and also include program information that provides programs aired during a certain period of time.

In the illustrated example, the viewership data 124 is a household-based viewership data. The household-based viewership data 124 can include various fields. In some embodiments, the household-based viewership data 124 include household IDs 340, tune-in dates 342, tune-in times 344, tune-out dates 346, tune-out times 348, and channel/network/station IDs 350. In other embodiments, the household-based viewership data 124 include only some of these fields. In yet other embodiments, the household-based viewership data 124 include other data fields.

The household ID 340 identifies a household that watched a program on a particular, channel, network, and/or station during a particular period of time.

The tune-in date 342 represents a date when the associated household began watching the program on the network or station.

The tune-in time 344 represents a time at which the associated household began watching the program on the network or station.

The tune-out date 346 indicates a date on which the associated household changed a channel or turned off the media delivery device 120 (e.g., a television) to stop watching the program.

The tune-out time 348 represents a time at which the associated household stopped watching the program.

The channel/network/station ID 350 represents a channel, network, or station that provided the particular program to the household through its media delivery device 120.

In some embodiments, the viewership data 124 do not include the tune-out dates 346 and the tune-out times 348. In this case, the viewership data 124 can be processed to determine viewing durations beginning from the tune-in dates 342 and the tune-in time 344. Various methods can be employed to determine such viewing durations. One example method employs an off curve function.

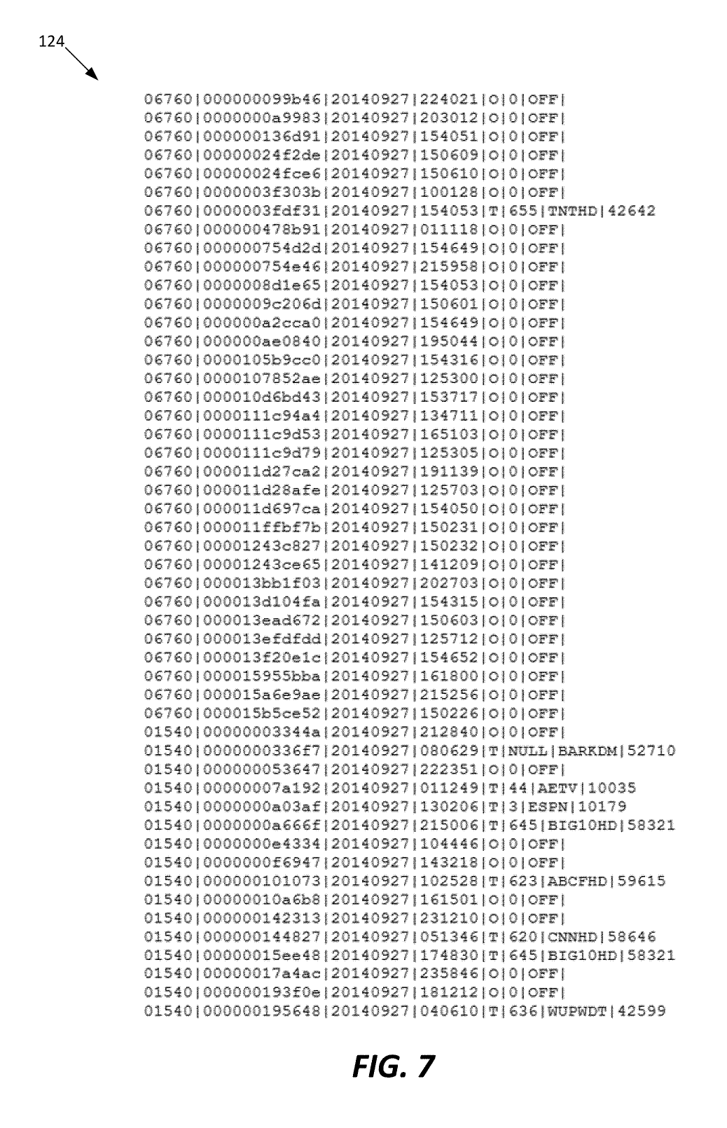

FIG. 7 illustrates a portion of example household-based viewership data 124 provided by a viewership data provider 108. In some embodiments, the viewership data provider 108 includes FourthWall Media, Comcast, Time Warner, Charter, and other cable providers. In some embodiments, the viewership data 124 is obtained using one or more viewership data collection devices 122, such as set top boxes, installed in each household so as to provide set top box events. The viewership data 124 provide viewership information including household viewing events. For example, the viewership data 124 record a tuning event every time a household changes the channel.

FIG. 8 illustrates an example structure of the individual-based viewership data 334. In some embodiments, as described herein, the individual-based viewership data 334 are transformed by the household-to-individual data transformation engine 330 from the household-based viewership data 124. In other embodiments, the individual-based viewership data 334 include only some of these fields. In yet other embodiments, the individual-based viewership data 334 include other data fields.

In some embodiments, the individual-based viewership data 334 are structured with two data tables including a tuning activity table 360 and an individual viewer information table 380. The tuning activity table 360 and the individual viewer information table 380 can be cross-referenced to provide detailed individual-based viewership information as necessary to generate the advertisement exposure data 324.

The tuning activity table 360 includes various fields. In some embodiments, the tuning activity table 360 includes individual viewer IDs 362, household IDs 364, and one or more fields for tuning activity information 366.

The individual viewer ID 362 identifies an individual that watched a program during a particular period of time.

The household ID 364 identifies a household associated with an individual identified by the corresponding individual viewer ID 362.

The fields for turning activity information 366 contain various pieces of viewership information, such as tune-in dates, tune-in times, tune-out dates, tune-out times, and network/station IDs, which are similar to those in the household-based viewership data 124 as described in FIG. 6.

The individual viewer information table 380 can include various fields. In some embodiments, the individual viewer information table 380 includes individual viewer IDs 382, one or more fields for names 384, one or more fields for geographic information 386, and one or more fields for demographic information 388. In some embodiments, the individual viewer information table 380 is provided by the household-to-individual data transformation engine 330.

The individual viewer ID 382 is used to identify an individual. In some embodiments, the tuning activity table 360 can refer to the individual viewer information table 380 by matching the individual viewer IDs 362 and 382.

The fields for name 384 contain the name (including the first and last names) of an individual identified by the individual viewer ID 382.

The fields for geographic information 386 include various pieces of geographic information, such as country, state, county, street, and house number, of an individual identified by the individual viewer ID 382. In other embodiments, the fields for geographic information 386 can also include additional information, such as congressional district, state legislative district, municipal district, zip code, census data, census block, latitude and longitude, GPS coordinates, cable television zone, current location, work location, home location, and the like.

The fields for demographic information 388 include various pieces of demographic information, such as gender, age, income level, education level, race, ethnicity, knowledge of languages, disabilities, mobility, home ownership, employment status, and the like.

Although the individual-based viewership data 334 are described to have two separate tables 360 and 380 that cross-reference each other, other embodiments of the individual-based viewership data 334 can have different data structures, such as a single data table or more than two data tables cross-referencing one another.

FIG. 9 illustrates an example structure of the advertisement run data 126. The advertisement run data 126 include a comprehensive time-stamped record of each advertisement that has been delivered to an advertisement audience, such as the consumer 104. In some embodiments, the AD run data 126 include advertisement IDs 402, time records 404, channel/network/station IDs 406, and geographic information 408. In other embodiments, the advertisement run data 126 include only some of these fields. In yet other embodiments, the advertisement run data 126 include other data fields.

The advertisement ID 402 identifies an advertisement that has been provided to the consumer 104 through the media delivery devices 120 (e.g., TVs).

The time record 404 indicates when a corresponding advertisement was presented to the consumer 104. In some embodiments, the time record 404 is provided with one or more data fields, such as dates, start times, and end times.

The channel/network/station ID 406 represents a channel, network, or station that provided the corresponding advertisement to the consumer 104.

The geographic information 408 include various pieces of geographic information, such as country, state, county, street, and house number, where the corresponding advertisement was presented to the consumer 104. In some embodiments, the time record 404 is provided with one or more data fields.

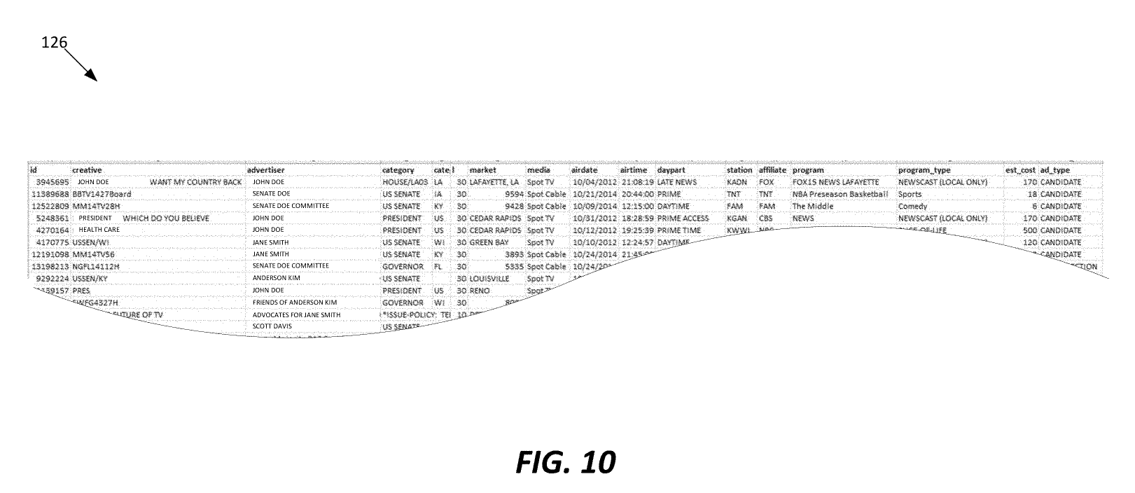

FIG. 10 illustrates a portion of example advertisement run data 126 provided by an advertisement run data provider 110. In some embodiments, the advertisement run data 126 include various pieces of information, such as advertisement IDs, advertisement themes or titles (“creative”), advertisers, advertisement categories, geographical information, markets, media, air dates, air times, day parts, affiliates, programs, program types, estimated costs, advertisement types, and any other suitable information.

FIG. 11 illustrates an example structure of the advertisement exposure data 324. The AD exposure data 324 include information of individuals that have been exposed to the advertising campaign. As described herein, the AD exposure data 324 are generated by cross-referencing and/or matching the individual-based viewership data 334 and the advertisement run data 126. The AD exposure data 324 can be generated by the advertisement exposure calculation engine 332, as described above. In some embodiments, the AD exposure data 324 indicate individuals that were exposed to particular advertisements through the media delivery devices 120 at a particular time period, channel, network, and/or station, and geographic location. The AD exposure data 324 can further include information about the number and/or kind of advertisements each individual was exposed to.

In the illustrated example of FIG. 11, the AD exposure data 324 include individual viewer IDs 422 and advertisement exposure information 424.

The individual viewer ID 422 is used to identify an individual.

The fields for the advertisement exposure information 424 categorize different advertisements (e.g., AD1, AD2, AD3, etc.), and indicate whether each individual identified by the individual viewer IDs 422 was exposed to one or more of the advertisements.

Referring to FIGS. 12-18, an example operation of the customer conversion analysis device 322 is described.

FIG. 12 is a block diagram of an example customer conversion analysis device 322. In some embodiments, the customer conversion analysis device 322 includes a propensity model generation engine 502 and a conversion outcome generation engine 504. Also shown is propensity-augmented conversion data 506.

The propensity model generation engine 502 is configured to reflect the inherent tendency that an outcome that is intended by the advertising campaign is naturally achieved without the advertising campaign. In some embodiments, the propensity model generation engine 502 operates to estimate the likelihood that each household or individual would have performed the action or the like desired by the advertising campaign if the campaign had not occurred. The propensity model generation engine 502 then operates to determine a propensity score for each household or individual based on the estimated probability. In some embodiments, the propensity score for each household or individual is be determined based on the likelihood that that household or individual is exposed to the advertising campaign. In some embodiments, the similarly scored households or individuals are grouped, and the differences in conversion events (such as conversion rates) in these groups are used to evaluate the effectiveness or impact of the advertising campaign.

In some embodiments, the propensity model generation engine 502 receives and processes the customer data 128 to generate the propensity-augmented conversion data 506.

The conversion outcome generation engine 504 is configured to receive the advertisement exposure data 324 and the propensity-augmented conversion data 506 and generate the customer conversion outcome 132. In some embodiments, the conversion outcome generation engine 504 generates the advertisement evaluation report 130 including the customer conversion outcome 132.

FIG. 13 illustrates an example structure of the customer data 128.

In general, the customer data 128 include information about customers of the goods, services, or the like that are promoted by the advertisement campaign. In some embodiments, the customer data 128 include personally identifiable information (PII) and individual conversion information. The conversion information tells whether an outcome, which is desired by the advertisement campaign, has been achieved. For example, the conversion information includes whether an individual performs an action (i.e., conversion action) intended by the advertisement campaign. In some embodiments, the conversion information contained in the customer data 128 does not distinguish the conversion actions with the advertisement campaign from those without the advertisement campaign.

The customer data 128 can include one or more data fields for various pieces of information. As shown in FIG. 13, in some embodiments, the customer data 128 include customer IDs 510, customer personal information 512, and conversion information 514.

The customer ID 510 is used to identify an individual customer.

The customer personal information 512 includes personal information associated with the customer ID 510. In some embodiments, the customer personal information 512 includes names 516, geographic information 518, and demographic information 520 of the customers. The names 516 can be identified with one or more fields for, for example, first and last names. The geographic information 518 is identified with one or more fields for, such as country, state, county, city, street, and house number. The demographic information 520 is identified with one or more fields for, such as, gender, age, income level, education level, race, ethnicity, knowledge of languages, disabilities, mobility, home ownership, employment status, and the like.

The conversion information 514 represents whether each customer changes his or her behavior or action that is desired by the advertisement campaign.

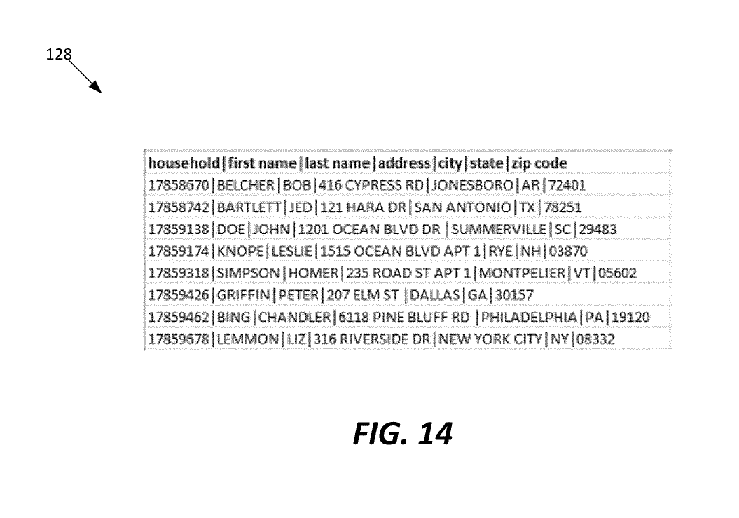

FIG. 14 illustrates a portion of example customer data 128 retrieved from the CRM database 112. In some embodiments, the customer data 128 includes various pieces of information, such as household IDs, customer names (e.g., first and last names), and geographical information (e.g., address, city, state, and zip code).

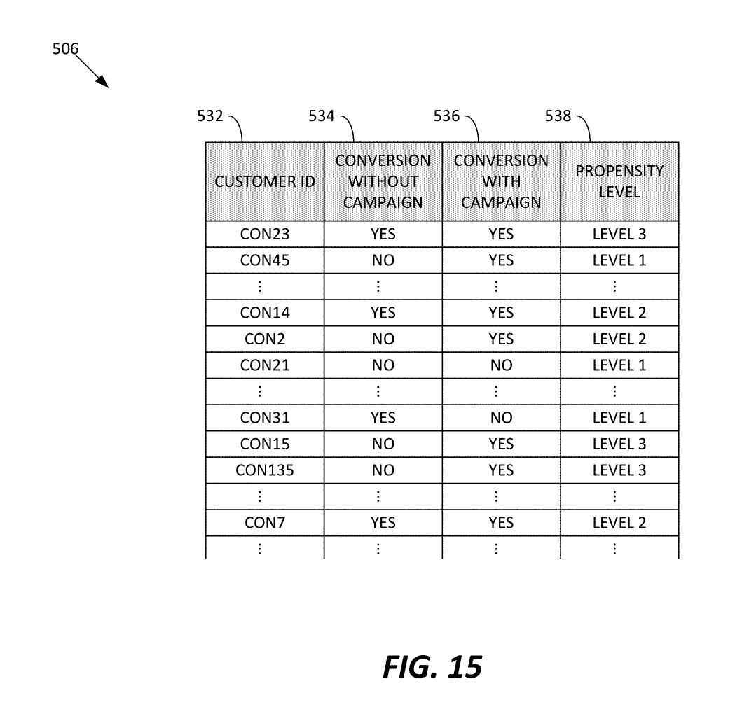

FIG. 15 illustrates an example structure of the propensity-augmented conversion data 506. As shown in FIG. 12, the propensity-augmented conversion data 506 is an output from the propensity model generation engine 502.

The propensity-augmented conversion data 506 include a plurality of groups of customers that are categorized by different levels of conversion propensity. In some embodiments, the conversion propensity is defined by a tendency that an outcome desired by the advertising campaign (e.g., a customer's action, such as purchase of an advertised product or attendance to an advertised event) would be achieved without the advertising campaign.

By way of example, the propensity-augmented conversion data 506 is illustrated with an example advertising campaign for promoting a running event. In some examples, an individual's television watching behavior can be correlated with such an individual's tendency to perform an action that is advertised. For example, people who do not watch television very often (e.g., very light television watchers) are more likely to join the running event. However, since such people rarely watch television, they would be hardly exposed to the advertisements of the running event. As a result, the advertising campaign is less likely to affect their decision to attend the running event. In contrast, heavy television watchers are less likely to run the race than the other group of people (e.g., the very light television watchers) is. However, the heavy television watchers are more exposed to the advertisements, the advertising campaign would more likely affect their conversion rate. As such, the conversion result after the advertising campaign alone does not accurately suggest the effectiveness of the campaign. In this regard, the propensity model generation engine 502 is configured to determine control conversion information (also referred to as reference conversion information) that indicates whether customers would have behaved as desired by the advertisement campaign if the advertising had not occurred.

Referring to FIG. 15, the propensity-augmented conversion data 506 includes customer IDs 532, control conversion information 534, effective conversion information 536, and propensity levels 538.

The customer IDs 532 is used to identify an individual customer.

The control conversion information 534 represents whether a desired outcome would have been achieved if the advertising campaign had not occurred. For example, the control conversion information 534 indicates whether a customer would have performed (e.g., attended the running event) even without the advertising campaign.

The effective conversion information 536 indicates whether the desired outcome has been achieved with the advertisement campaign. For example, the effective conversion information 536 shows whether the desired outcome (e.g., customer's performance as desired by the advertising campaign) happens after the advertising campaign. In some embodiments, the effective conversion information 536 is obtained from the conversion information 514 included in the customer data 128. In other embodiments, the effective conversion information 536 is identical to the conversion information 514 of the customer data 128 for the same customer.

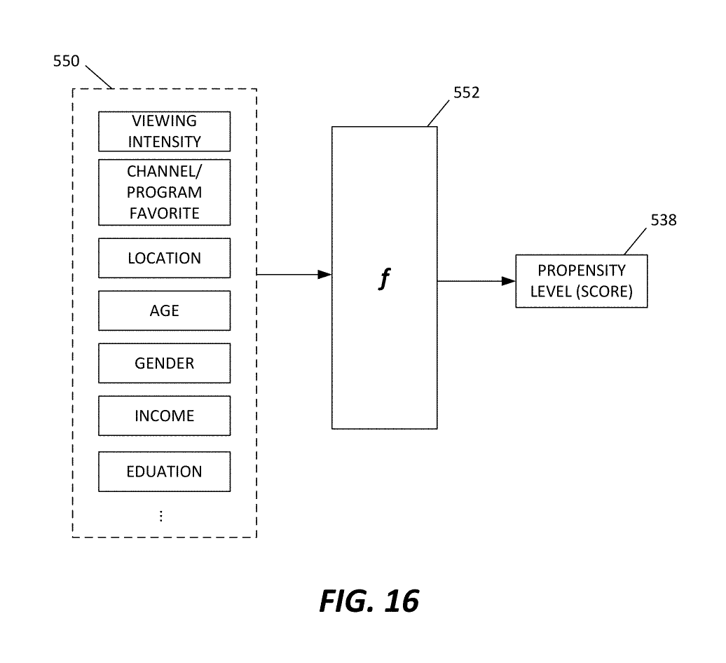

The propensity level 538 indicates a level of conversion propensity of each customer identified by the customer IDs 532. The propensity level 538 is used to categorize the customers into different groups by different levels of conversion propensity as shown in the customer conversion outcome 132. In some embodiments, the propensity levels 538 include propensity scores. An example method of determining the propensity levels is described with reference to FIG. 16.

FIG. 16 illustrates an example method of determining the propensity levels 583. Illustrated are one or more variables 550 and a propensity function 552, as well as the propensity levels 583.

The variables 550 represent different criteria that affect the conversion propensity of customers. The variables 550 that are used to calculate the propensity levels of customers can vary, depending on the characteristics of an outcome desired by the advertising campaign. In some embodiments, the variables 550 include at least one of viewing intensity, channel preference, program preference, geographic location, and demographic factors (such as gender, age, income level, education level, race, ethnicity, knowledge of languages, disabilities, mobility, home ownership, employment status, and the like). Other factors can also be the variables 550 in other embodiments.

For example, where the running event is promoted by an advertising campaign, the television watching intensity can be a factor that affects customers' conversion propensity. Other factors, such as channel preference and/or program preference, can also affect the customer's propensity to join the running event. By way of example, people who watch ESPN heavily can have different behaviors than people who watch Comedy Channel or MSNBC heavily. In other examples, people of a higher income bracket are more likely to buy a luxury vehicle than people of a lower income bracket.

The propensity function 552 is configured to consider at least one of the variables 550 and generate the propensity levels 538 of the customers. In some embodiments, the propensity levels 538 are represented by numerical scores. Alternatively or in addition, other methods can be used to represent the propensity levels 538 in other embodiments.

Referring again to FIG. 12, the propensity model generation engine 502 receives and processes the customer data 128 including the conversion information 514 (e.g., conversion results on an individual-by-individual basis), and generates the propensity-augmented conversion data 506 that include the control conversion information 534 and the propensity level 538 for each customer. In some embodiments, the customers with the same propensity level (or similar propensity scores) are grouped to compare difference in conversion rate therebetween.

With continued reference to FIG. 12, the conversion outcome generation engine 504 operates to match the propensity-augmented conversion data 506 with the individual-based advertisement exposure data 324 and generate the customer conversion outcome 132. The customer conversion outcome 132 can be incorporated in the advertisement evaluation report 130. The customer conversion outcome 312 can show the difference in conversion events (e.g., conversion rates) before and after the advertising campaign, thereby representing the effectiveness of the advertising campaign. Examples of the customer conversion outcome 132 are described and illustrated in more detail with reference to FIGS. 17 and 18.

Referring to FIGS. 17 and 18, examples of the customer conversion outcome 132 are described. In general, the customer conversion outcome 132 shows the overall increase in customer conversions after advertising campaign (or at least part of the advertising campaign). In some embodiments, the overall increase in the customer conversions can be categorized into a plurality of groups with different propensity levels.

FIG. 17 illustrates an example customer conversion outcome 132. In some embodiments, the customer conversion outcome 132 shows a pre-advertising conversion rate 562, a post-advertising conversion rate 564, an increment rate 566, a number of exposed customers 568, and a number of effective conversions 570.

The pre-advertising conversion rate 562 represents the customers who have converted without the advertising campaign. In some embodiments, the pre-advertising conversion rate 562 is a ratio of the number of customers that have converted, or would have converted, without the advertising campaign to the number of sample customers. In the illustrated example, 5% of the sample customers (i.e., the customers that are sampled for evaluation) has changed their behavior, or performed an action as desired by the advertising campaign, without the advertising campaign. Alternatively, the pre-advertising conversion rate 562 can indicate that 5% of the sample customers would have changed their behavior, or would have performed the action, without the advertising campaign.

The post-advertising conversion rate 564 represents the customers who have converted after the advertising campaign. In some embodiments, the post-advertising conversion rate 564 is a ratio of the number of customers that have converted with the advertising campaign. In the illustrated example, 9% of the sample customers has changed their behavior, or performed the action, with the advertising campaign.

The increment rate 566 shows a difference between the pre-advertising conversion rate 562 and the post-advertising conversion rate 564. In the illustrated example, the increment rate 566 is 4%, which is a change in rate between the post-advertising conversion rate 564 (i.e., 9%) and the pre-advertising conversion rate 562 (i.e., 5%).

The number of exposed customers 568 is a number of customers who have been exposed to the advertising campaign. In some embodiments, the number of exposed customers 568 represents a number of exposed customers among the sample group of customers.

The number of effective conversions 570 represents a number of conversions attributed to the advertising campaign. In some embodiments, the number of effective conversions 570 indicates a number of customers who have converted due to the advertising campaign. In some embodiments, the number of effective conversions 570 is calculated by multiplying the number of exposed customers 568 by the increment rate 566.

FIG. 18 illustrates another example customer conversion outcome 132. In some embodiments, the customer conversion outcome 132 shows a propensity level 572, in addition to the information included in the example customer conversion outcome 132 of FIG. 17 (such as the pre-advertising conversion rate 562, the post-advertising conversion rate 564, the increment rate 566, the number of exposed customers 568, and the number of effective conversions 570).

In this example, the information included in the customer conversion outcome 132 of FIG. 17 is sorted by different propensity levels 572. As described herein, the propensity levels 572 can corresponds to a plurality of customer groups having different propensity levels. As described in FIG. 15, a propensity level represents a natural tendency that customers have to convert as intended by the advertising campaign. As described herein, customers can be grouped based on their propensity scores generated by a predictive model.

In some embodiments, the pre-advertising conversion rate 562, the post-advertising conversion rate 564, the increment rate 566, the number of exposed customers 568, and the number of effective conversions 570 are presented by each propensity level 572.

In the illustrated example, the propensity levels 572 are listed as propensity level 1, propensity level 2, propensity level 3, and so forth. In some embodiments, the propensity levels 572 can be determined by different ranges of propensity scores. In other embodiments, the propensity levels 572 can be divided by a predetermined number of different degrees (e.g., high, medium, and low).

As such, the customer conversion outcome 132 in this example can show the percentage lift of advertising campaign based on different advertisement exposure levels, as well as the overall percentage lift of the advertising campaign.

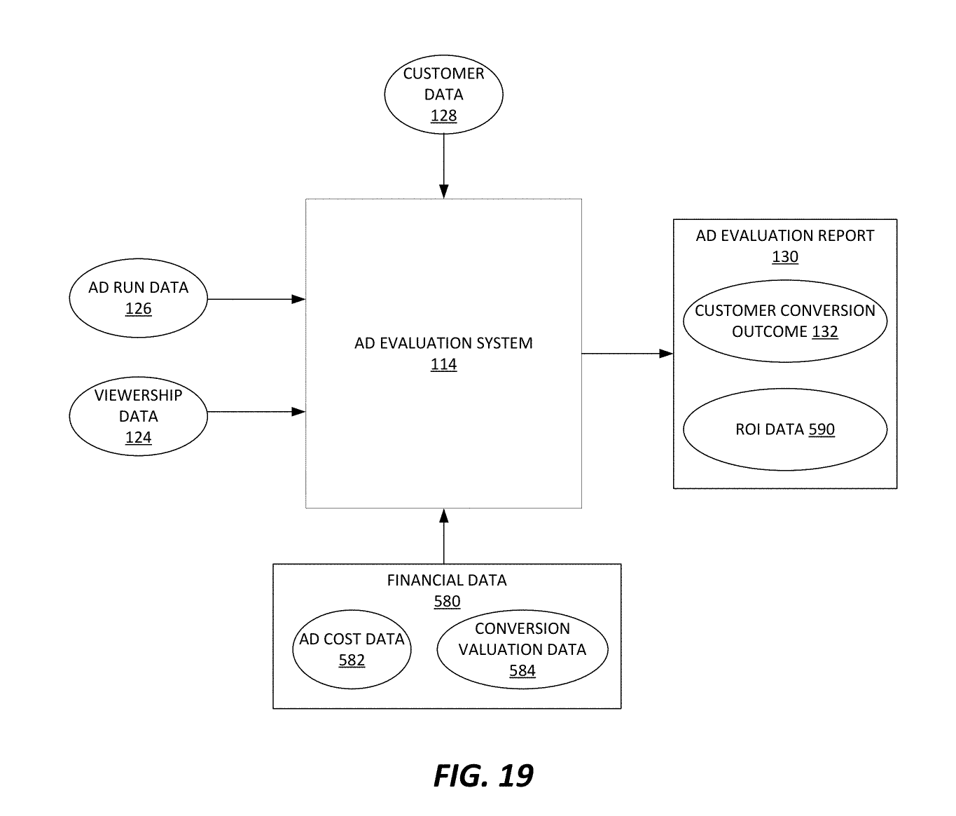

FIG. 19 is a block diagram of another example advertisement evaluation system 114. The advertisement evaluation system 114 in this example is similarly configured to the system 114 of FIG. 4. Therefore, the description for the advertisement evaluation system 114 is omitted for brevity purposes, and the following description will be limited primarily to additional features for this example.

In this example, the advertisement evaluation system 114 operates to receive advertisement financial data 580 and generate a return on investment (ROI) data 590 of the advertising campaign.

In some embodiments, the advertisement financial data 580 include advertisement cost data 582 and conversion valuation data 584.

The advertisement cost data 582 include information about a cost to deliver advertising campaign to the consumer 104. In some embodiments, the advertisement cost data 582 include an overall cost to perform the entire advertising campaign. For example, the advertisement cost data 582 include the total cost for the placement blocks for the advertising campaign. In other embodiments, the advertising cost data 582 include a cost for delivering each advertisement to the consumer 104. For example, the advertising cost data 582 include pricing information about each placement block for advertising. In yet other embodiments, the advertising cost data 582 include information about advertising cost determined in various manners, such as a cost per each viewer.

In some embodiments, the advertisement cost data 582 can be part of other data that are used in the advertisement evaluation system 114. For example, the advertisement cost data 582 can be part of the advertisement run data 126.

The conversion valuation data 584 include information indicating how much each customer conversion event is worth to the advertiser 102. In some embodiments, the conversion valuation data 584 include information about a cost per each customer conversion. For example, the conversion valuation data 584 include the total cost to achieve the customer conversions, and/or the profits that the advertiser 102 derives from the customer conversions. In some embodiments, future revenue data of the advertiser 102 can be considered to generate the conversion valuation data 584.

With the advertisement financial data 580, the advertisement evaluation system 114 generates the return on investment (ROI) data 590. In some embodiments, the return on investment data 590 is included in the advertisement evaluation report 130.

In some embodiments, the return on investment data 590 is generated by cross-referencing and/or matching a plurality of data files used in the advertisement evaluation system 114. The data used to generate the return on investment data 590 include at least one of the viewership data 124, the advertisement run data 126, the customer data 128, the advertisement exposure data 324, the individual-based viewership data 334, the propensity-augmented conversion data 506, and the advertisement financial data 580 including the advertisement cost data 582 and the conversion valuation data 584. Other data can also be used in other embodiments.

In some embodiments, the return on investment data 590 includes statistics of return on investments. The statistics can be determined in various manners. For example, the return on investment can be calculated for the overall advertising campaign. In other examples, the return on investment can be determined based on different customer conversion levels (e.g., different levels of advertisement exposure). In yet other examples, the return on investment can be calculated based on each advertisement, each set of the same advertisements, and/or each set of advertisements of the same characteristics (e.g., advertising theme, type, etc.).

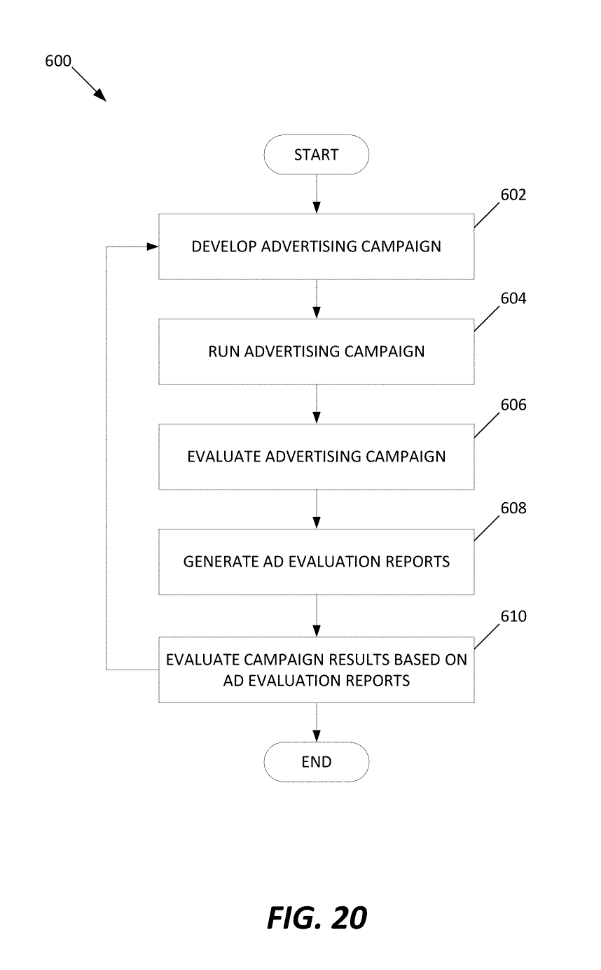

FIG. 20 is a flowchart illustrating an example method 600 of evaluating the effectiveness of advertising campaign. In some embodiments, the method 600 includes operations 602, 604, 606, 608, and 610.

At the operation 602, the advertiser 102 develops an advertising campaign based on a particular campaign theme. The campaign theme is a central idea or message that will be communicated in promotional activities (e.g., to promote a running event).

At the operation 604, the advertiser 102 runs the advertising campaign through the media provider 106.

At the operation 606, the advertising campaign is then evaluated by the advertisement evaluation system 114.

At the operation 608, the advertisement evaluation report 130 is generated by the advertisement evaluation system 114. In some embodiments, a plurality of advertisement evaluation reports 130 are created by the advertisement evaluation system 114 and delivered to the advertiser 102. As described herein, the advertisement evaluation reports 130 include the customer conversion outcome 132 and/or the return on investment data 590. In some embodiments, the advertisement evaluation reports 130 can be formatted in digital document versions, such as Microsoft Word, Excel, or PowerPoint, and Portable Document Format (PDF).

At the operation 610, a campaign result (e.g., the effectiveness of advertising campaign) is evaluated based on one or more of the advertisement evaluation reports 130. In some embodiments, the advertiser 102 performs such evaluation of the advertising campaign. In other embodiments, the advertisement evaluation system 114, and/or an entity operating the advertisement evaluation system 114, is configured to evaluate the result based on the reports 130. In yet other embodiments, a third party can perform the evaluation for the advertiser 102. Based on the evaluation result, the advertiser 102 can adjust the current advertising campaign or develop a new advertising campaign to improve the return on investment.

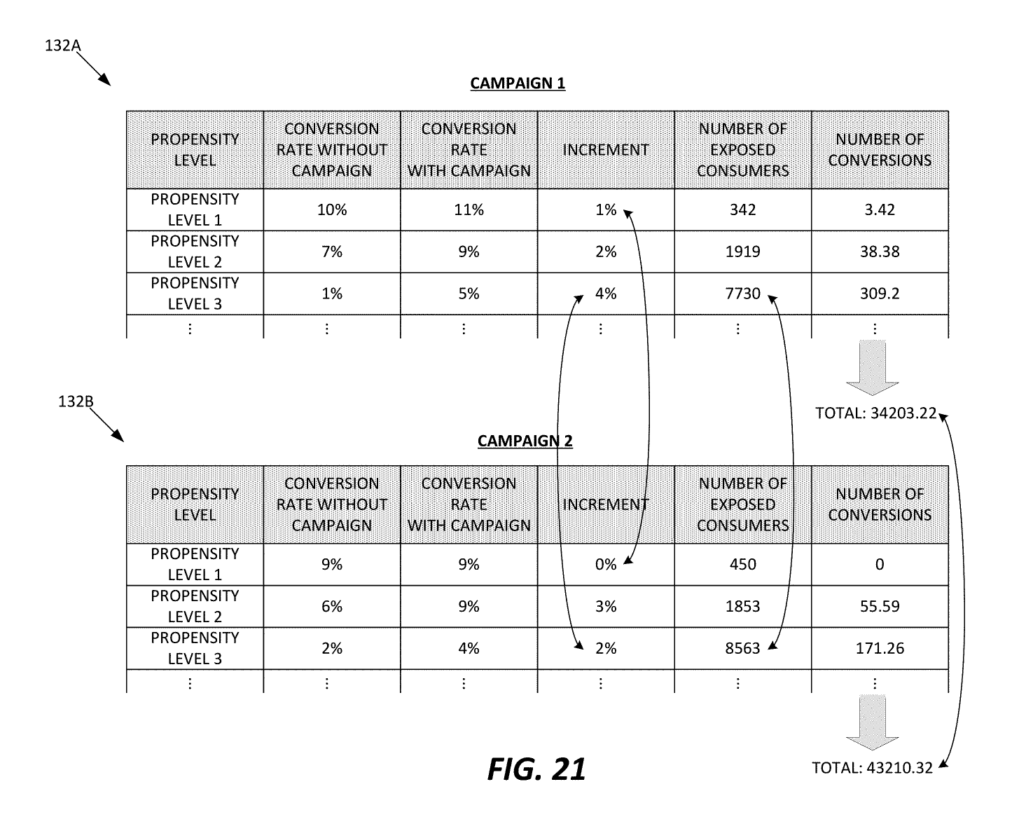

FIG. 21 shows two example customer conversion outcomes 132 (including a first customer conversion outcome 132A and a second customer conversion outcome 132B) to illustrate example evaluation methods. The first and second customer conversion outcomes 132A and 132B are included in different advertisement evaluation reports 130. In other embodiments, the first and second customer conversion outcomes 132A and 132B are included in the same advertisement evaluation report 130.

In some embodiments, the first customer conversion outcome 132A is generated after a first advertising campaign, and the second customer conversion outcome 132B is generated after a second advertising campaign. The first and second customer conversion outcomes 132A and 132B can be compared in various aspects to evaluate the effectiveness between the first and second advertising campaigns.

In some examples, the same propensity levels from the outcomes 132A and 132B are compared to evaluate the effectiveness of the advertising campaigns for customers in the propensity level. For example, the increment rate (e.g., 4%) of the third propensity level group from the first customer conversion outcome 132A is compared with the increment rate of the third propensity level group (e.g., 2%) from the second customer conversion outcome 132B. Alternatively, the number of exposed customers (e.g., 7,730) of the third propensity level group from the first customer conversion outcome 132A is compared with the number of exposed customers of the third propensity level group (e.g., 8,563) from the second customer conversion outcome 132B.

In other embodiments, a total of a particular field can be compared to evaluate the effectiveness of the advertising campaigns overall. For example, the total number of effective conversions (e.g., 34,203.22) from the first customer conversion outcome 132A is compared with the total number of effectiveness conversions (e.g., 43,210.32) from the second customer conversion outcome 132B.

In yet other embodiments, the customer conversion outcomes 132A and 132B, and/or other information contained in the advertisement evaluation reports 130, can be compared in many different aspects to evaluate the effectiveness of advertising campaigns.

In the present disclosure, the system 100 is illustrated and described primarily on an advertising campaign for a running event on broadcasting televisions and/or cable televisions. However, the system 100 can be employed to evaluate the effectiveness of other types of advertising campaign, such as product or service promotion and political campaign. Further, the system 100 of the present disclosure can be used in the same or similar manner with other types of campaign, such as radio advertising, online streaming advertising, text messages, banner messages, video messages, roll-over messages, text over video messages, and any other advertising formats. For example, embodiments of the system 100 can be expanded to measure other advertising media or program delivery sources, such as the Internet, radio, handheld devices, wireless devices (e.g., mobile phones), television distribution systems, cable, satellite, programs delivered through television networks, “TiVo” type systems, “DirectTV” type systems, and many others.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer storage medium comprising computer executable instructions that, when executed by at least one processing device, cause the at least one processing device to:
receive viewership data and advertisement run data;
generate advertisement exposure data based on the viewership data and the advertisement run data, the advertisement exposure data including information about advertisements presented to an advertisement audience;
receive customer data, the customer data including conversion information that represents whether a desired outcome has been achieved by the advertisement campaign; and
generate a customer conversion outcome based on the advertisement exposure data and the customer data.

2. The computer storage medium of claim 1, wherein the computer executable instructions further cause the at least one processing device to:
prior to generating a customer conversion outcome, determine control conversion information that represents whether customers perform the action without the advertisement campaign, the control conversion information included in the customer data; and
determine effective conversion information that represents whether customers preform the action with the advertisement campaign, the effective conversion information included in the customer data.

3. The computer storage medium of claim 1, wherein the computer executable instructions further cause the at least one processing device to:
prior to generating a customer conversion outcome, generate a propensity-augmented conversion data, the propensity-augmented conversion data including a plurality of groups of customers categorized by different levels of propensity, the propensity defined by a tendency that a customer have to perform the action,
wherein generating a customer conversion outcome includes generating a customer conversion outcome based on the advertisement exposure data and the propensity-augmented conversion data.

4. The computer storage medium of claim 1, wherein:
the viewership data include information about tuning activities of households; and
the advertisement run data include information about advertisements delivered to the households.

5. The computer storage medium of claim 1, wherein the computer executable instructions further cause the at least one processing device to:
generate an advertisement evaluation report, the advertisement evaluation report including the customer conversion outcome.

6. A system of evaluating an advertising campaign, the system comprising:
at least one processing devices;
a computer readable storage device storing software instructions that, when executed by the one or more computing devices, cause the one or more processing devices to:
receive viewership data and advertisement run data;
generate advertisement exposure data based on the viewership data and the advertisement run data, the advertisement exposure data including information about advertisements presented to an advertisement audience;
receive customer data, the customer data including conversion information that represents whether a desired outcome has been achieved by the advertisement campaign; and
generate a customer conversion outcome based on the advertisement exposure data and the customer data.

7. The system of claim 6, wherein the computer executable instructions further cause the at least one processing device to:
prior to generating a customer conversion outcome, determine control conversion information that represents whether customers perform the action without the advertisement campaign, the control conversion information included in the customer data; and
determine effective conversion information that represents whether customers preform the action with the advertisement campaign, the effective conversion information included in the customer data.

8. The system of claim 6, wherein the computer executable instructions further cause the at least one processing device to:
prior to generating a customer conversion outcome, generate a propensity-augmented conversion data, the propensity-augmented conversion data including a plurality of groups of customers categorized by different levels of propensity, the propensity defined by a tendency that a customer have to perform the action,
wherein generating a customer conversion outcome includes generating a customer conversion outcome based on the advertisement exposure data and the propensity-augmented conversion data.

9. The system of claim 6, wherein:
the viewership data include information about tuning activities of households; and
the advertisement run data include information about advertisements delivered to the households.

10. The system of claim 6, wherein the computer executable instructions further cause the at least one processing device to:
generate an advertisement evaluation report, the advertisement evaluation report including the customer conversion outcome.

11. A method of evaluating an advertising campaign, the method comprising:
receiving viewership data and advertisement run data;
generating, using at least one computing device, advertisement exposure data based on the viewership data and the advertisement run data, the advertisement exposure data including information about advertisements presented to an advertisement audience;
receiving customer data, the customer data including conversion information that represents whether a desired outcome has been achieved by the advertisement campaign; and
generating, using the at least one computing device, a customer conversion outcome based on the advertisement exposure data and the customer data.

12. The method of claim 11, further comprising:
prior to generating a customer conversion outcome, determining control conversion information that represents whether customers perform the action without the advertisement campaign, the control conversion information included in the customer data; and
determining effective conversion information that represents whether customers preform the action with the advertisement campaign, the effective conversion information included in the customer data.

13. The method of claim 11, further comprising:
prior to generating a customer conversion outcome, generating a propensity-augmented conversion data, the propensity-augmented conversion data including a plurality of groups of customers categorized by different levels of propensity, the propensity defined by a tendency that a customer have to perform the action,
wherein generating a customer conversion outcome includes generating a customer conversion outcome based on the advertisement exposure data and the propensity-augmented conversion data.

14. The method of claim 11, wherein:
the viewership data include information about tuning activities of households; and
the advertisement run data include information about advertisements delivered to the households.

15. The method of claim 11, further comprising:
generating an advertisement evaluation report, the advertisement evaluation report including the customer conversion outcome.
